(19) United States
(12) Patent Application Publication
(10) Pub. No.: US 2011/0268298 A1
(43) Pub. Date: Nov. 3, 2011

(54) SOUND FIELD CORRECTING DEVICE

(75) Inventors: Yoshitomo Imanishi, Fujimi (JP); Yoshiki Ohta, Sakado (JP); Kensaku Obata, Kawasaki (JP); Akihiro Iseki, Kawasaki (JP)

(73) Assignee: PIONEER CORPORATION, Kanagawa (JP)

(21) Appl. No.: 13/141,581

(22) PCT Filed: Dec. 25, 2008
(86) PCT No.: PCT/JP2008/073575

§ 371 Date: Jul. 11, 2011

(51) Int. Cl. H04R 5/00

(52) U.S. Cl. 381/303

(57) ABSTRACT

At least two speakers are arranged in the left-right direction, and the measurement signal generating unit generates the measurement signal from the two speakers. The measurement signal outputting unit outputs the measurement signal. The measurement signal collecting unit collects the measurement signal for the left-right direction from at least two positions along the left-right direction axis in the acoustic space. The delay correcting unit performs the delay adjustment for any one of the speakers in the acoustic space, based on information that the measurement signal collecting unit obtains by collecting the measurement signal for the left-right direction, until the level difference in the left-right direction becomes equal to or smaller than the predetermined value. The sound field correcting device collects the measurement signal from two positions along the left-right direction axis, and reduces the level difference in the left-right direction based on the information obtained by collecting the sound.

### TECHNICAL FIELD

The present invention relates to a device for correcting a sound field.

### BACKGROUND TECHNIQUE

In an audio system having a plurality of speakers and providing a high-quality acoustic space, it is required to automatically create an appropriate acoustic space with presence. Namely, since it is quite difficult to appropriately adjust acoustic characteristics of reproduced sound reproduced by plural speakers if a listener operates an audio system by himself or herself to create an appropriate acoustic space, it is required for the audio system to automatically correct the sound field characteristics.

For example, since listening positions are asymmetric and sound localization is disturbed in a vehicle compartment, as shown in FIG. 13, the distance from each speaker SP and the level of each speaker SP are automatically corrected by using the position of the speaker SP1, which is farthest from the listening position RV, as a reference. Namely, the audio signals outputted by the speakers SP are delayed as if those speakers are located at the positions of the speakers SP2-2 to SP5-2. As a method of an automatic correction, there is a method of obtaining the signals outputted from the speakers SP1 to SP5 by a microphone MK and performing the correction based on information thus obtained, as shown in FIG. 14.

In this case, ideally, it is necessary that virtual sound sources VS1 to VS5 are located at the forward direction of the listening position RV as shown in FIG. 15. However, as a result of an investigation, for some users, of the position of the virtual sound source after the automatic correction, it is found that the virtual sound sources VS11 to VS15 are located in the left-forward direction of the listening position RV and the localization is biased as shown in FIG. 16.

In addition, when the front-rear level difference and the left-right level difference at the listening position are actually measured, it is found as shown in FIG. 17 that the front-rear level difference is small, but the left-right level difference exists and the level is high in the left direction.

Therefore, it is desired to provide an appropriate sound field environment by reducing the left-right level difference and the localization is corrected to the forward direction. As a system having sound collecting units in the left-right direction to correct the sound field, there are known an acoustic characteristic measuring device disclosed in Patent Reference-1 and an automatic sound field correcting system in a vehicle compartment.

Patent Reference-1: Japanese Patent Application Laid-open under No. 2008-11342

Patent Reference-2: Japanese Patent Application Laid-open under No. 1-107-212890

### DISCLOSURE OF INVENTION

### Problem to be Solved by the Invention

However, the acoustic characteristic measuring device of Patent Reference-1 obtains the sounds outputted from each of the speakers by the sound collecting units in the left-right direction and averages the obtained information to correct the speakers. Therefore, the level difference in the left-right direction is not directly reduced.

The automatic sound field correcting system in a vehicle compartment according to Patent Reference-2 includes plural sound collecting units, but does not describe how to use information collected by the sound collecting units.

The above is one example of problems to be solved by the present invention. It is an object of the present invention to provide a sound field correcting device which cancels a level difference in a left-right direction.

### Means for Solving the Problem

According to the invention described in claim 1, a sound field correcting device, which performs sound field correction for at least two speakers arranged in a left-right direction in an acoustic space, includes: a measurement signal generating unit which generates a measurement signal; a measurement signal outputting unit which outputs the measurement signal from the two speakers, at a same time, as the measurement signal for the left-right direction of the acoustic space; a measurement signal collecting unit which collects the measurement signal for the left-right direction from at least two positions along a left-right direction axis in the acoustic space; and a delay correcting unit which performs delay adjustment for any one of the speakers in the acoustic space, based on information that the measurement signal collecting unit obtains by collecting the measurement signal for the left-right direction, until a level difference in the left-right direction becomes equal to or smaller than a predetermined value.

According to the invention described in claim 7, a sound field correcting method, which performs sound field correction for at least two speakers arranged in a left-right direction in an acoustic space, includes: a measurement signal generating process which generates a measurement signal; a measurement signal outputting process which outputs the measurement signal from the two speakers, at a same time, as the measurement signal for the left-right direction of the acoustic space; a measurement signal collecting process which collects the measurement signal for the left-right direction from the at least two speakers along a left-right direction axis in the acoustic space; and a delay correcting process which performs delay adjustment for any one of the speakers in the acoustic space, based on information that the measurement signal collecting process obtains by collecting the measurement signal for the left-right direction, until a level difference in the left-right direction becomes equal to or smaller than a predetermined value.

According to the invention described in claim 8, a sound field correcting program, executed by a device which performs sound field correction for at least two speakers arranged in a left-right direction in an acoustic space, makes the device function as: a measurement signal generating unit which generates a measurement signal; a measurement signal outputting unit which outputs the measurement signal from the two speakers, at a same time, as the measurement signal for the left-right direction of the acoustic space; a measurement signal collecting unit which collects the measurement signal for the left-right direction from the at least two speakers along a left-right direction axis in the acoustic space; and a delay correcting unit which performs delay adjustment for any one of the speakers in the acoustic space, based on information that the measurement signal collecting unit obtains by collecting the measurement signal for the left-right direction, until a level difference in the left-right direction becomes equal to or smaller than a predetermined value.

### BRIEF DESCRIPTION OF THE DRAWINGS

FIG. 1 is a diagram schematically illustrating a basic configuration for measuring a signal delay time.

FIG. 2 is a diagram illustrating a configuration of an audio system.

FIG. 3 is a diagram illustrating an example of arrangement of speakers.

FIG. 4 is a diagram illustrating an internal configuration of a signal processing circuit.

FIG. 5 is a block diagram illustrating a configuration of a signal processing unit.

FIG. 6 is a block diagram illustrating a configuration of a coefficient operating unit.

FIGS. 7A and 7B are block diagrams illustrating a configuration of a correcting unit.

FIGS. 8A and 8B are diagrams for explaining axis.

FIG. 9 is a block diagram illustrating the audio system.

FIGS. 10A and 10B are diagrams for explaining a method of determining a delay object speaker.

FIG. 11 is a flowchart of a sound field correcting process.

FIGS. 12A and 12B are graphs illustrating level differences after sound field correcting process is executed.

FIG. 13 is a diagram schematically illustrating a conventional sound field correction.

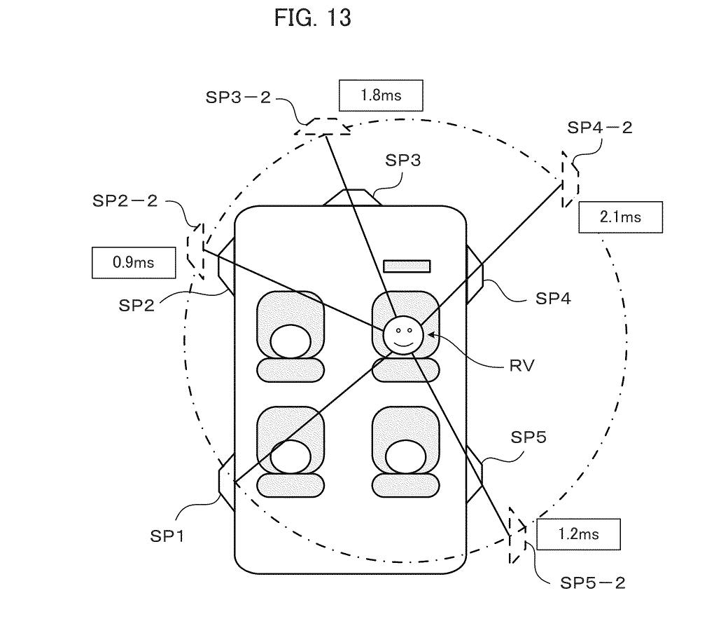

FIG. 14 is a diagram illustrating an arrangement example of microphones in a conventional sound field correcting device.

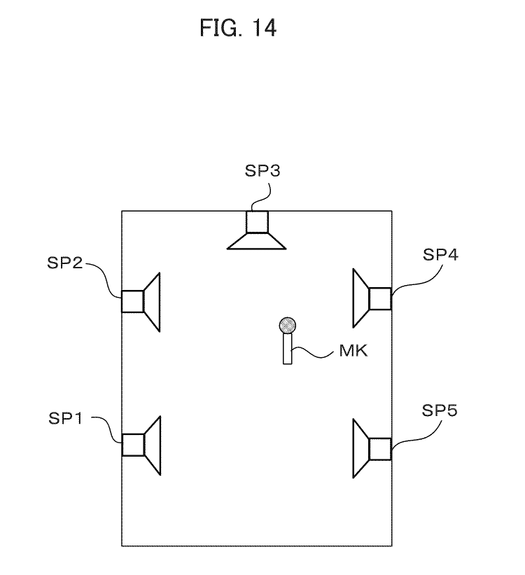

FIG. 15 is an arrangement example of ideal virtual sound sources.

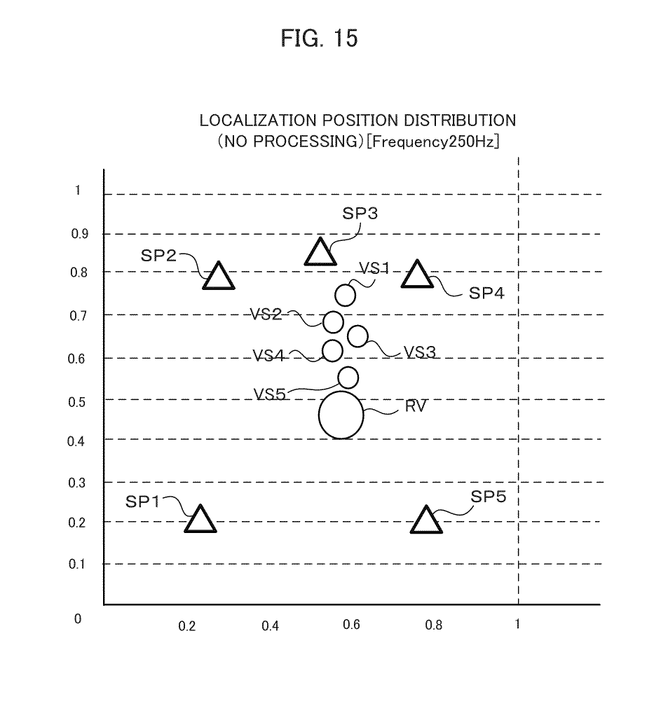

FIG. 16 is a diagram illustrating an arrangement of virtual sound sources after the conventional sound field correction.

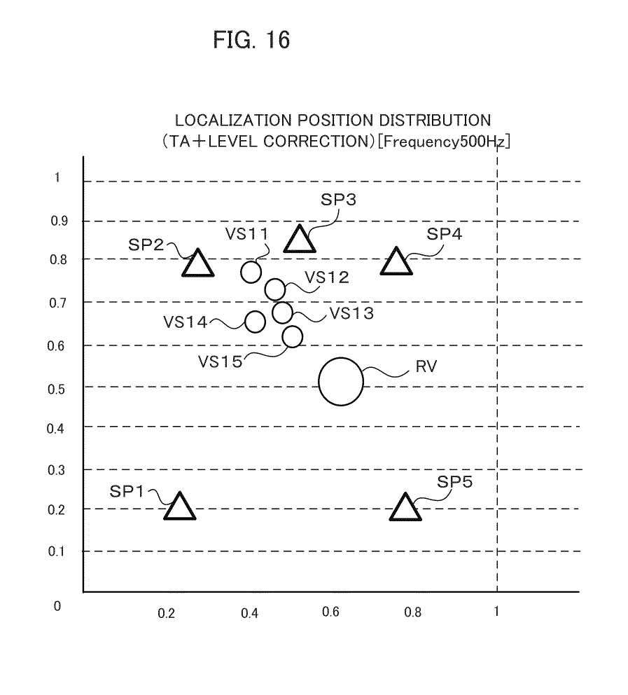

FIG. 17 is a graph illustrating conventional level differences.

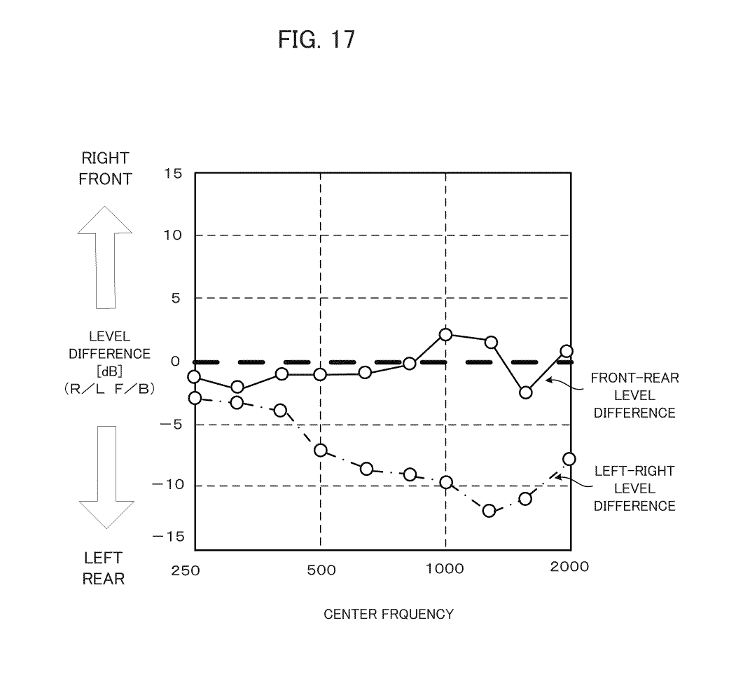

### BRIEF DESCRIPTION OF REFERENCE NUMBERS

51 Initial correcting unit

52 Measurement signal generating unit

53 Measurement signal outputting unit

54 Measurement signal collecting unit

55 Delay correcting unit

56 Delay adjustment object speaker determining unit

100 Audio system

### DETAILED DESCRIPTION OF THE PREFERRED EMBODIMENTS

According to one aspect of the present invention, there is provided a sound field correcting device which performs sound field correction for at least two speakers arranged in a left-right direction in an acoustic space, including: a measurement signal generating unit which generates a measurement signal; a measurement signal outputting unit which outputs the measurement signal from the two speakers, at a same time, as the measurement signal for the left-right direction of the acoustic space; a measurement signal collecting unit which collects the measurement signal for the left-right direction from at least two positions along a left-right direction axis in the acoustic space; and a delay correcting unit which performs delay adjustment for any one of the speakers in the acoustic space, based on information that the measurement signal collecting unit obtains by collecting the measurement signal for the left-right direction, until a level difference in the left-right direction becomes equal to or smaller than a predetermined value.

The above sound field correcting device may be applied to a device which corrects a sound field in a vehicle. At least two speakers are arranged in the left-right direction in the acoustic space, and the measurement signal generating unit generates the measurement signal (e.g., pink noise) from the above two speakers. The measurement signal outputting unit outputs the measurement signal to outside. The measurement signal collecting unit collects the measurement signal for the left-right direction from at least two positions along the left-right direction axis in the acoustic space. The delay correcting unit performs the delay adjustment for any one of the speakers in the acoustic space, based on information that the measurement signal collecting unit obtains by collecting the measurement signal for the left-right direction, until the level difference in the left-right direction becomes equal to or smaller than the predetermined value.

In this case, the sound field correcting device collects the measurement signal from two positions along the left-right direction axis, and reduces the level difference in the left-right direction based on the information obtained by collecting the sound. Therefore, it is possible to reduce the difference between the left-right sound pressure levels at the listening position, generated when a simple time-alignment is performed based on the distances between the listening position and the speakers, thereby providing more appropriate acoustic space.

In one mode of the above sound field correcting device, the delay correcting unit performs the delay adjustment for the speakers arranged in the left-right direction. In this case, the sound field correcting device performs the delay adjustment for the speakers in the left-right direction, by which the level difference in the left-right direction can be directly adjusted. Thereby, the sound field correcting device can appropriately reduce the level difference in the left-right direction.

In another mode of the above sound field correcting device, the acoustic space includes at least a speaker arranged in a longitudinal direction, in addition to the speakers arranged in the left-right direction, the measurement signal outputting unit makes the speakers in the acoustic field output a measurement signal for the longitudinal direction at the same time, the measurement signal collecting unit collects the measurement signal for the longitudinal direction from at least two positions along a longitudinal direction axis in the acoustic space, and the delay correcting unit performs the delay adjustment for the speaker arranged in the longitudinal direction, based on information obtained by collecting the measurement signal for the longitudinal direction, until a level difference in the longitudinal direction becomes equal to or smaller than a predetermined value. In this case, the delay correcting unit detects, not only the level difference in the lateral direction in the acoustic space, but the level difference in the longitudinal direction, and performs the correction such that the level difference in the longitudinal direction is reduced. Therefore, the sound field correcting device can provide more appropriate acoustic space.

In another mode of the sound field correcting device, predetermined delay values are set beforehand for the speakers arranged in the acoustic space. In this case, since the sound field correcting device sets the delay values beforehand, the number of times of the sound field correction can be reduced.

The delay correcting unit performs the delay adjustment for the speaker belonging to one of areas, which is created by dividing the acoustic space by a first reference axis perpendicular to the left-right direction and passing through a listening position located at a center of the measurement signal collecting unit and which includes smaller number of the speakers, or for the speaker arranged closer to the listening position, when the delay correcting unit performs the delay adjustment for the speakers arranged in the left-right direction. In this case, since the sound field correcting device performs the correction process with limiting the speaker subjected to the correction, it is not necessary to perform the correction for multiple speakers and the correction process can be simplified.

The delay correcting unit performs the delay adjustment for the speaker belonging to one of areas, which is created by dividing the acoustic space by a second reference axis perpendicular to the longitudinal direction and passing through a center of the listening position and which includes smaller number of the speakers, or for the speaker arranged closer to the listening position, when the delay correcting unit performs the delay adjustment for the speaker arranged in the longitudinal direction. Also in this case, since the sound field correcting device performs the correction process with limiting the speaker subjected to the correction, it is not necessary to perform the correction for multiple speakers and the correction process can be simplified.

According to another aspect of the present invention, there is provided a sound field correcting method which performs sound field correction for at least two speakers arranged in a left-right direction in an acoustic space, including: a measurement signal generating process which generates a measurement signal; a measurement signal outputting process which outputs the measurement signal from the two speakers, at a same time, as the measurement signal for the left-right direction of the acoustic space; a measurement signal collecting process which collects the measurement signal for the left-right direction from the at least two positions along a left-right direction axis in the acoustic space; and a delay correcting process which performs delay adjustment for any one of the speakers in the acoustic space, based on information that the measurement signal collecting process obtains by collecting the measurement signal for the left-right direction, until a level difference in the left-right direction becomes equal to or smaller than a predetermined value.

The above sound correcting method also collects the measurement signal from two positions along the left-right direction axis, and reduces the level difference in the left-right direction based on the information obtained by collecting the sound. Therefore, it is possible to reduce the difference between the left-right sound pressure level at the listening position, generated when a simple time-alignment is performed based on the distances between the listening position and the speakers, thereby providing more appropriate acoustic space.

According to still another aspect of the present invention, there is provided a sound field correcting program executed by a device which performs sound field correction for at least two speakers arranged in a left-right direction in an acoustic space, the program making the device function as: a measurement signal generating unit which generates a measurement signal; a measurement signal outputting unit which outputs the measurement signal from the two speakers, at a same time, as the measurement signal for the left-right direction of the acoustic space; a measurement signal collecting unit which collects the measurement signal for the left-right direction from the at least two positions along a left-right direction axis in the acoustic space; and a delay correcting unit which performs delay adjustment for any one of the speakers in the acoustic space, based on information that the measurement signal collecting unit obtains by collecting the measurement signal for the left-right direction, until a level difference in the left-right direction becomes equal to or smaller than a predetermined value.

By executing the program on various devices, the sound field correcting device according to the present invention can be realized.

### EMBODIMENT

A preferred embodiment of the present invention will be described below with reference to the attached drawings.

[Description of Outline]

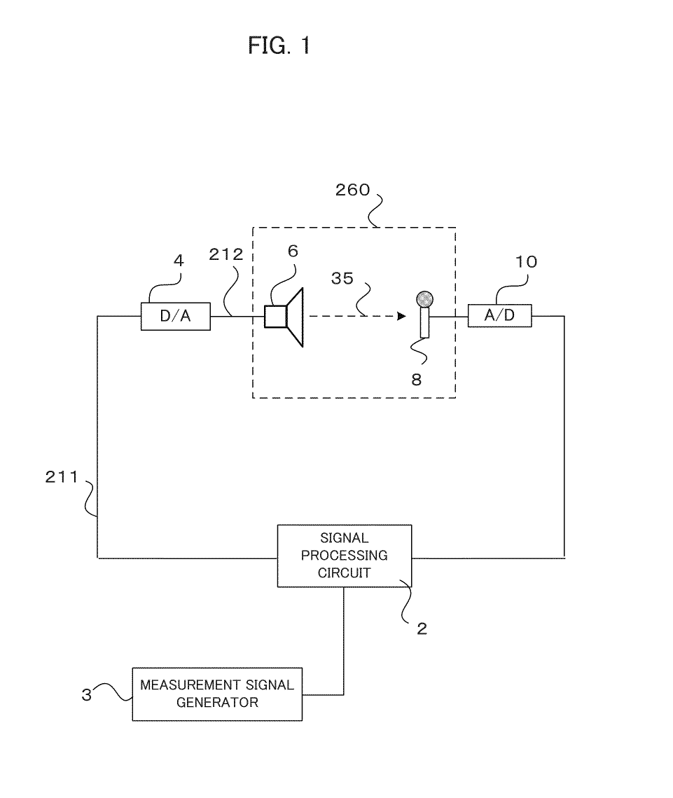

First, an outline of a signal delay time measurement according to the present invention will be described. FIG. 1 schematically illustrates a basic configuration for the signal delay time measurement. As illustrated, a device for performing the signal delay time measurement includes a signal processing circuit 2, a measurement signal generator 3, a D/A converter 4, speakers 6, microphones 8 and an A/D converter 10. The speakers 6 and the microphones 8 are arranged in an acoustic space 260. It is noted that the acoustic space 260 in this embodiment is a space in a vehicle compartment.

The measurement signal generator 3 generates a pulse signal as a measurement signal 211, and supplies it to the signal processing circuit 2. The measurement signal may be stored in a memory or the like in the measurement signal generator 3 as a digital signal. The signal processing circuit 2 supplies the measurement signal 211 to the D/A converter 4. The D/A converter 4 converts the measurement signal 211 to an analog measurement signal 212, and supplies it to the speaker 6. The speaker 6 outputs measurement pulse sound 35 corresponding to the measurement signal 212 to the acoustic space 260 as the measurement signal sound. In this embodiment, six speakers 6 are provided, and four microphones 4 are provided, in total, at the left, right, front and rear position of the listening position. A concrete example of the measurement signal is a signal of various random noises such as pink noise or a pulse signal. While the measurement signal is a pulse signal in this embodiment, other various signals may be used.

In the present invention, the measurement signal 211 is obtained via the microphones 8 arranged at left and right sides to detect a left-right level difference at the listening position, and the delay correction is performed in accordance with the left-right level difference.

[Audio System]

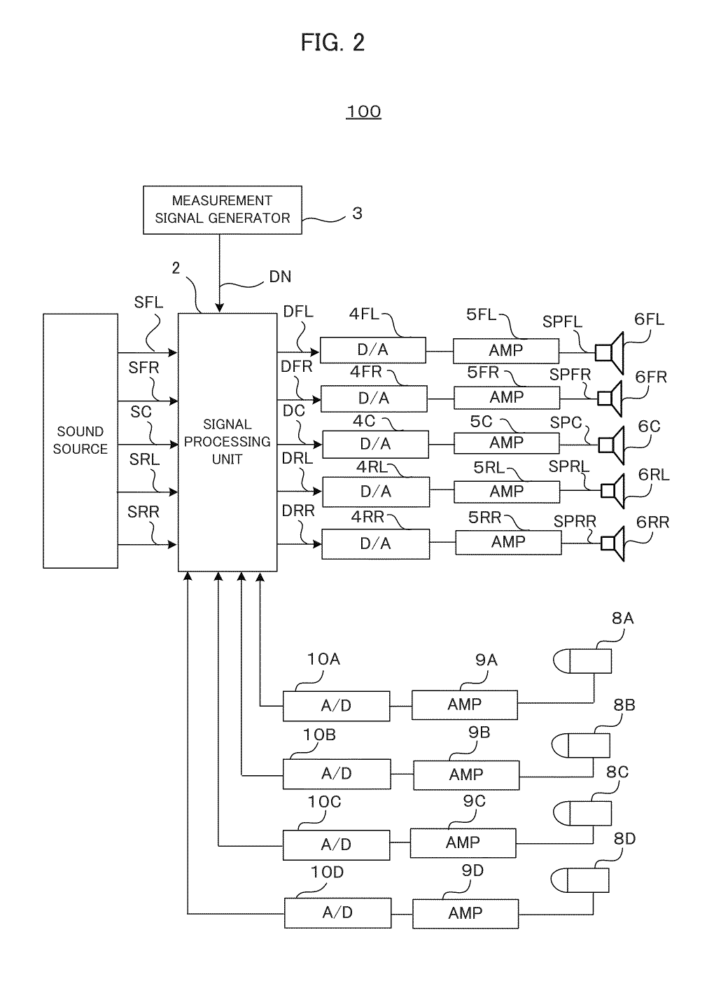

FIG. 2 is a block diagram illustrating a configuration of an audio system including an automatic sound field correcting system according to this embodiment.

In FIG. 2, the audio system 100 includes the signal processing circuit 2 to which digital audio signals SFL, SFR, SC, SRL and SRR are supplied from a sound source 1 such as a CD (Compact Disc) player or a DVD (Digital Video or versatile Disc) player via signal transmission paths of multiple channels, and the measurement signal generator 3.

The audio system 100 includes the signal transmission paths of multiple channels. In the following description, each channel will be expressed as “FL-channel”, “FR-channel”, respectively. In expressing the signals and the components, when all the multiple channels are referred to, the suffix of the reference numeral may be omitted. When the signal and the component of the individual channel are referred to, the suffix is attached. For example, “the digital audio signals S” means the digital audio signals SFL to SRR of all the channels, and “the digital audio signal SFL” means the digital audio signal of only the FL-channel.

Further, the audio system 100 includes D/A converters 4FL to 4RR which convert the digital outputs DFL to DRR subjected to the signal processing by the signal processing circuit 2 by the channel unit to the analog signals, and amplifiers 5FL to 5RR which amplify each of the analog audio signals outputted from the D/A converters 4FL to 4RR. Each of the analog audio signals SPFL to SPRR amplified by the amplifiers 5 are supplied to the speakers 6FL to 6RR of the multiple channels arranged in the automatic sound field correcting system as shown in FIG. 1 to be outputted as sound.

Further, the audio system 100 includes microphones 8A to 8D which collect reproduced sound at the listening position RV, amplifiers 9A to 9D which amplify collected sound signals outputted by the microphones 8, and A/D converters 10A to 10D which convert the outputs of the amplifiers 9A to 9D to digital collected sound data and supply them to the signal processing circuit 2.

The audio system 100 activates the full-band type speakers 6FL, 6FR, 6C, 6RL, 6RR, having the frequency characteristic capable of reproducing sound for substantially whole audio frequency band, thereby to provide the listener at the listening position with an acoustic space with present.

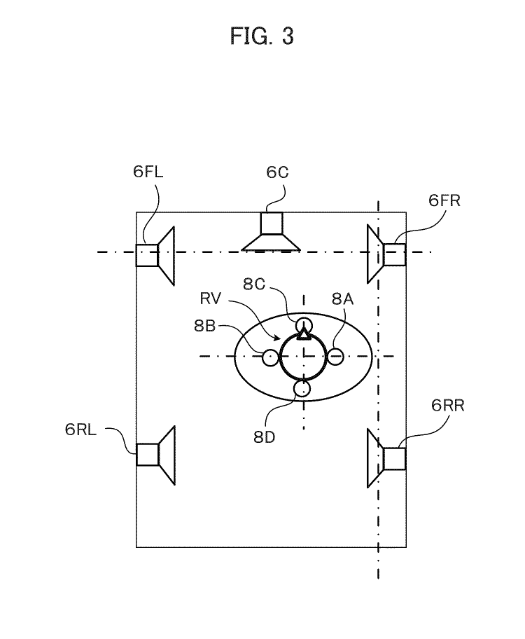

As the arrangement of the speakers, for example, as shown in FIG. 3, the front speakers 6FL, 6FR of the left and right 2 channels (the front left speaker and the front right speaker) and the center speaker 6c are arranged in front of the listening position RV. In addition, the rear speakers 6RL, 6RR of the left and right 2 channels (the rear left speaker and the rear right speaker) are arranged behind the listening position RV. The automatic sound field correcting system installed in the audio system 100 supplies the analog audio signals SPFL to SPRR, whose delay characteristics are corrected, to those five speakers 6FL to 6RR to be outputted, thereby creating an acoustic space with presence. The microphones 8A and 8B are arranged in the left-right direction of the listening position RV, and the microphones 8C and 8D are arranged in the front-rear direction of the listening position RV.

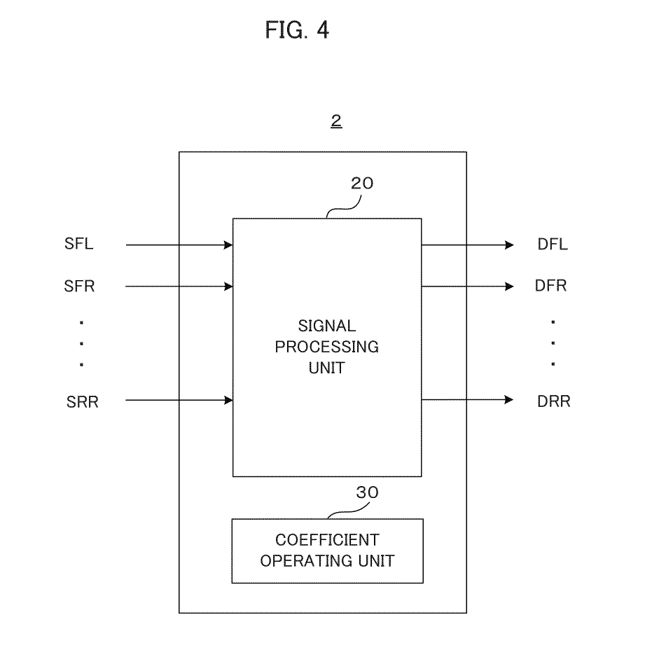

The signal processing circuit 2 is configured by a digital signal processor (DSP) and the like, and roughly includes a signal processing unit 20 and a coefficient operating unit 30 as shown in FIG. 4. The signal processing unit 20 receives the digital audio signals of multiple channels from the sound source 1 reproducing various music sources such as CD, DVD and so on, and applies the delay characteristic correction to them to output the digital output signals DFL to DRR.

The coefficient operating unit 30 receives the signals collected by the microphones 8 as the digital collected sound data, generates the correction coefficient signals and supplies them to the signal processing unit 20.

The signal processing unit 20 performs appropriate delay characteristic correction based on the collected sound data from the microphones 8, thereby optimum signals are outputted by each of the speakers 6.

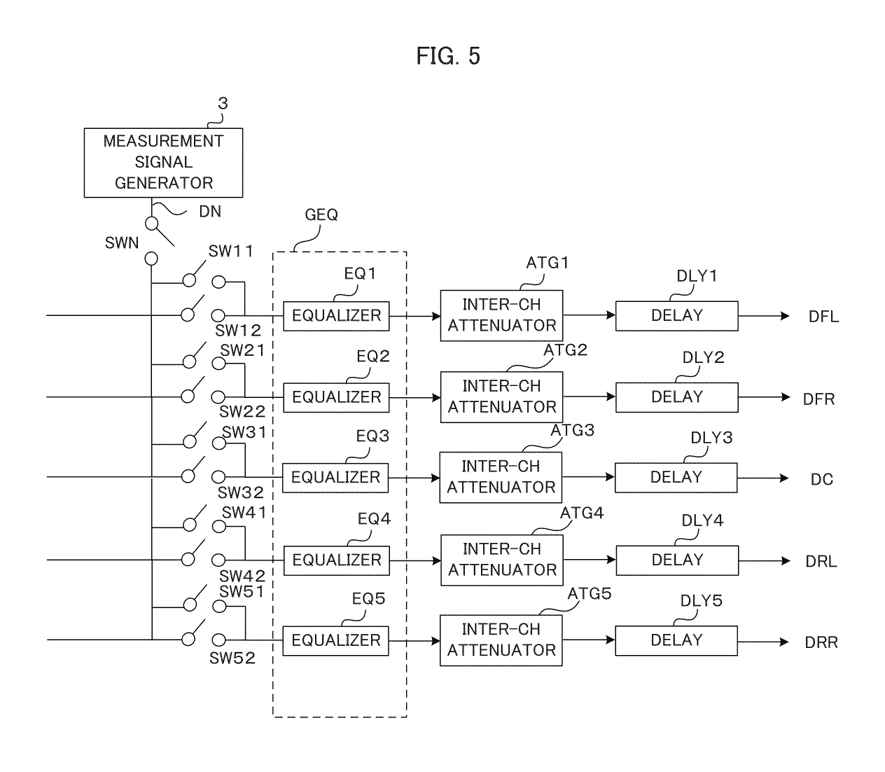

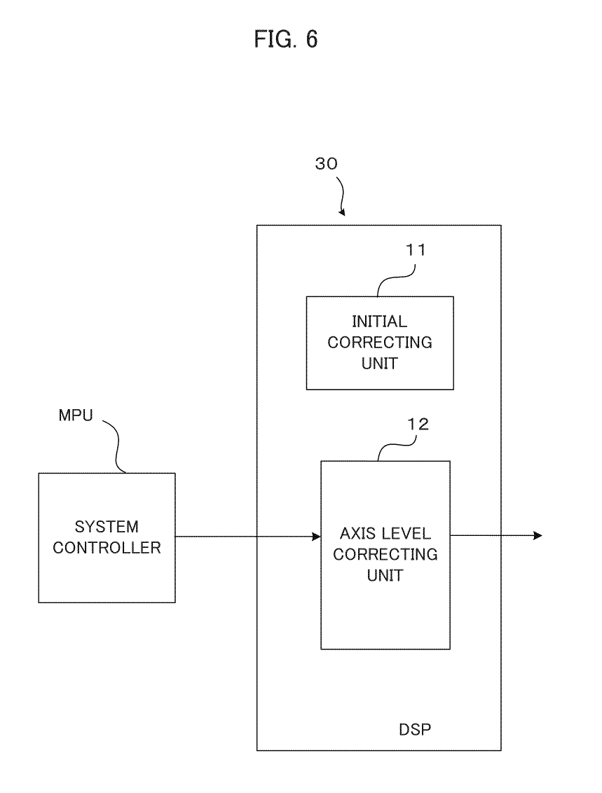

As shown in FIG. 5, the signal processing unit 20 includes graphic equalizers GEQ, inter-channel attenuators ATG1 to ATG5 and delay circuits DLY1 to DLY5. As shown in FIG. 6, the coefficient operating unit 30 includes a system controller MPU, an initial correcting unit 11 and an axis level correcting unit 12. The initial correcting unit 11 and the axis level correcting unit 12 constitutes a DSP. The system controller totally controls the audio system 100.

The audio system 100 has two modes as operation modes, i.e., an automatic sound field correcting mode and a sound source signal reproducing mode. The automatic sound field correcting mode is an adjusting mode performed prior to the signal reproduction from the sound source 1, and performs the automatic sound field correction for the environment where the audio system is installed. Thereafter, the audio signal is reproduced from the sound source 1 such as CD in the sound source signal reproducing mode. The present invention mainly relates to the correction processing in the automatic sound field correcting mode.

With reference to FIG. 5, to the FL-channel equalizer EQ1, the switching element SW12 which controls ON/OFF of the input of the digital audio signal SFL from the sound source 1 and the switching element SW11 which controls ON/OFF of the input of the measurement signal DN from the measurement signal generator 3. The switching element SW11 is connected to the measurement signal generator 3 via the switching element SWN.

The switching elements SW11, SW12, SWN are controlled by the system controller MPU constituted by the microprocessor shown in FIG. 6. At the time of reproducing the sound source signal, the switching element SW12 is set to ON (conductive), and the switching elements SW11 and SWN are set to OFF (nonconductive). At the time of the sound field correction, the switching element SW12 is set to OFF, and the switching element SW11 and SWN are set to ON.

The inter-channel attenuator ATG1 is connected to the output contact of the equalizer EQ1, and the delay circuit DLY1 is connected to the output contact of the inter-channel attenuator ATG1. The output DFL of the delay circuit DLY1 is supplied to the D/A converter 4FL shown in FIG. 2.

Other channels have the same configuration as that of FL-channel, and are provided with the switching elements SW21 to SW51 corresponding to the switching element SW11 and the switching elements SW22 to SW52 corresponding to the switching element SW12. Following the switching elements SW21 to SW52, there are provided the equalizers EQ2 to EQ5, the inter-channel attenuators ATG2 to ATG5 and the delay circuits DLY2 to DLY5. The outputs DFR to DRR of the delay circuits DLY2 to DLY5 are supplied to the D/A converters 4FR to 4RR shown in FIG. 2.

Further, each of the inter-channel attenuators ATG1 to ATG5 varies its attenuation rate within the range from 0 dB in minus side, according to the adjusting signals SG1 to SG5 from the axis level correcting unit 12. The delay circuits DLY1 to DLY5 of each channel varies the delay time of the inputted signal according to the adjusting signal from the initial correcting unit 11 and the axis level correcting unit 12.

The initial correcting unit 11 will be described. The initial correcting unit 11 calculates the delay amount based on the distance between the listening position RV and each of the speakers.

Specifically, by switching the switching elements SW11 to SW52 in order, the measurement signal DN generated by the measurement signal generator 3 for each channel is outputted by each speaker 6, and is collected by the microphone 8 to generate the collected sound data. If the measurement signal is a pulse signal such as an impulse for example, the difference between the time when the pulse measurement signal is outputted from the speaker 6 and the time when the pulse signal corresponding thereto is received by the microphone 8 is in proportion to the distance between the speaker 6 and the microphone 8 for each channel. Therefore, by setting the delay time of the channel having the largest delay amount, out of the delay times of the channels obtained by the measurement, to the delay times of other channels, the distance difference between the speaker 6 and the listening position RV can be absorbed for each channel. Thus, the delay of the signal generated by the speaker 6 of each channel can be equal, and the sounds of the time coincident with each other on the time axis and outputted from the multiple speakers 6 reach the listening position RV at the same time.

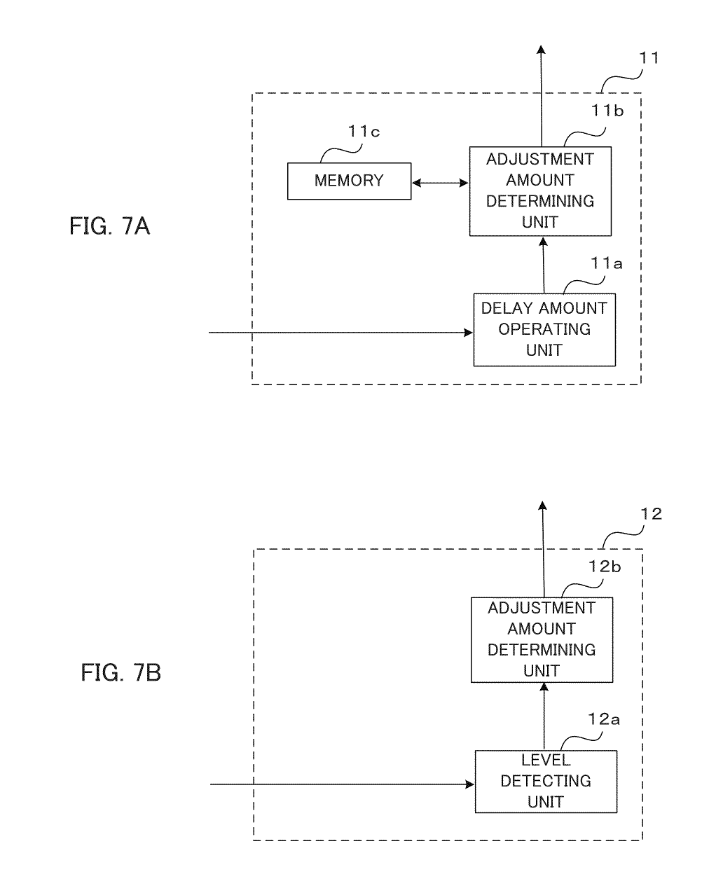

FIG. 7A illustrates the configuration of the initial correcting unit 11. The delay amount operating unit 11a receives the collected sound data DM, and operates the signal delay amount (time) by the sound field environment for each channel, based on the pulse delay amount between the pulse measurement signal and the collected sound data. The adjustment amount determining unit 11b receives the signal delay amount for each channel from the delay amount operating unit 11a, and temporarily stores it in the memory 11c. When the signal delay amount is calculated for all the channels and stored in the memory 11c, the adjustment amount determining unit 11b determines the adjustment amount for each channel such that the reproduced signals of other channels reach the listening point RV at the same time the reproduced signal of the channel having the largest signal delay amount reaches the listening position RV, and supplies the adjusting signal to the delay circuits DLY1 to DLY5 of each channel. Each of the delay circuits DLY1 to DLY5 adjusts the delay amount in accordance with the adjusting signal. Thus, the delay characteristic of each channel is adjusted. While the pulse signal is used as the measurement signal for the delay adjustment in the above example, the present invention is not limited to this example, and other measurement signal may be used.

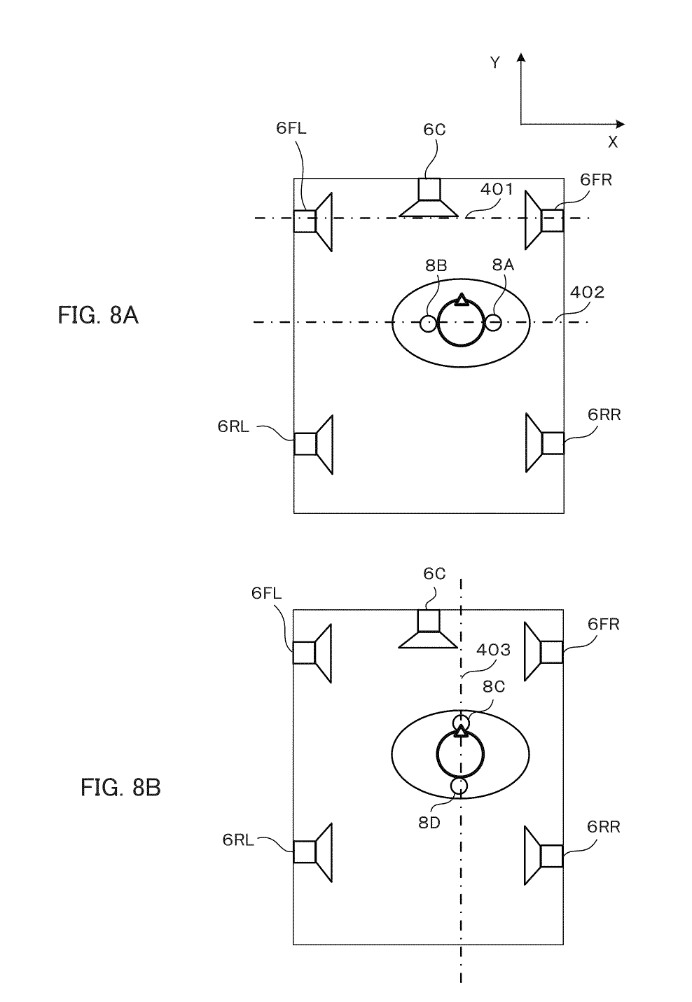

The axis level correcting unit 12 will be described. The axis level correcting unit 12 has a function to make the level differences of the left-right axis and the front-rear axis substantially zero. As shown in FIG. 7B, the axis level correcting unit 12 includes a level detecting unit 12 and an adjustment amount determining unit 12b. Here, the axis will be described with reference to FIGS. 8A and 8B. In FIGS. 8A and 8B, the lateral direction is prescribed as X-direction and the longitudinal direction is prescribed as Y-direction. As shown in FIG. 8A, in this embodiment, the axis of the X-direction passing thorough the speaker 6FL, the speaker 6C and the speaker 6FR, which are the front speakers, is prescribed as the axis 401. The microphone arranged on the axis 402 in parallel with the axis 401 is prescribed as the microphone of the X-axis direction. Namely, the microphone of the X-axis direction is arranged in parallel with the alignment of the front speakers. Further, as shown in FIG. 8B, multiple microphones arranged on the axis 403, which is the Y-direction axis perpendicular to the axis 402, is prescribed as the microphone of the Y-axis direction.

Specifically, when the speakers 6FL, 6C and 6FR are sounded at the same time by the measurement signal (e.g., pink noise) DN outputted from the measurement signal generator 3, the level detecting unit 12a obtains the left-right level difference at the listening position RV obtained via the microphones 8A and 8B. When the obtained level difference is not substantially zero, the adjustment amount determining unit 12b adjusts the delay amounts of the speakers 6. In addition, when the five speakers 6 are sounded at the same time by the measurement signal DN outputted by the measurement signal generator 3, the level detecting unit 12a obtains the front-rear level difference at the listening position RV obtained via the microphones 8C and 8D. When the obtained level difference is not substantially zero, the adjustment amount determining unit 12b adjusts the delay amounts of the speakers 6.

[Function of Audio System]

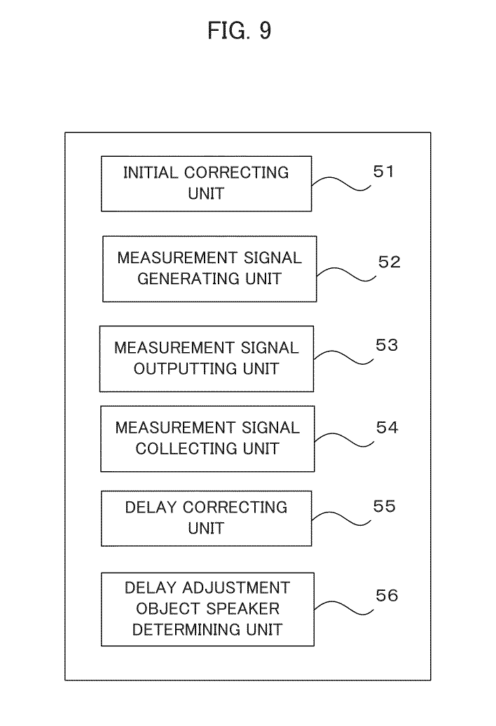

Next, FIG. 9 illustrates the functional block diagram of the audio system 100. As shown in FIG. 9, the audio system 100 includes an initial correcting unit 51, a measurement signal generating unit 52, a measurement signal outputting unit 53, a measurement signal collecting unit 54, a delay correcting unit 55 and a delay adjusting object speaker determining unit 56.

The initial correcting unit 51 determines the delay amount based on the listening position RV and the position of each speaker 6. In this embodiment, the initial correcting unit 51 is realized by the system controller operating the initial correcting unit 11 in the coefficient operating unit 30.

The measurement signal generating unit 52 generates the measurement signal. In this embodiment, the measurement signal generating unit 52 is realized by the system controller making the measurement signal generator 3 generate the measurement signal.

The measurement signal outputting unit 53 makes the multiple speakers 6 output the measurement signal generated by the measurement signal generating unit 52 at the same time. In this embodiment, the measurement signal outputting unit 53 is realized by the system controller requesting the signal processing circuit 2 to output the measurement signal.

The measurement signal collecting unit 54 obtains information that is produced by collecting the measurement signal, outputted by the measurement signal outputting unit 53, by the microphone 8. In this embodiment, the measurement signal collecting unit 54 is realized by the system controller making the signal processing circuit 2 obtain the information collected by the microphone 8.

The delay correcting unit 55 detects the level difference of the left-right axis or the front-rear axis based on the information collected by the measurement signal collecting unit 54. When the level difference of the axis is equal to or larger than a predetermined value, the delay correcting unit 55 varies the delay amount for the speaker determined by the delay adjusting object speaker determining unit 56 described below.

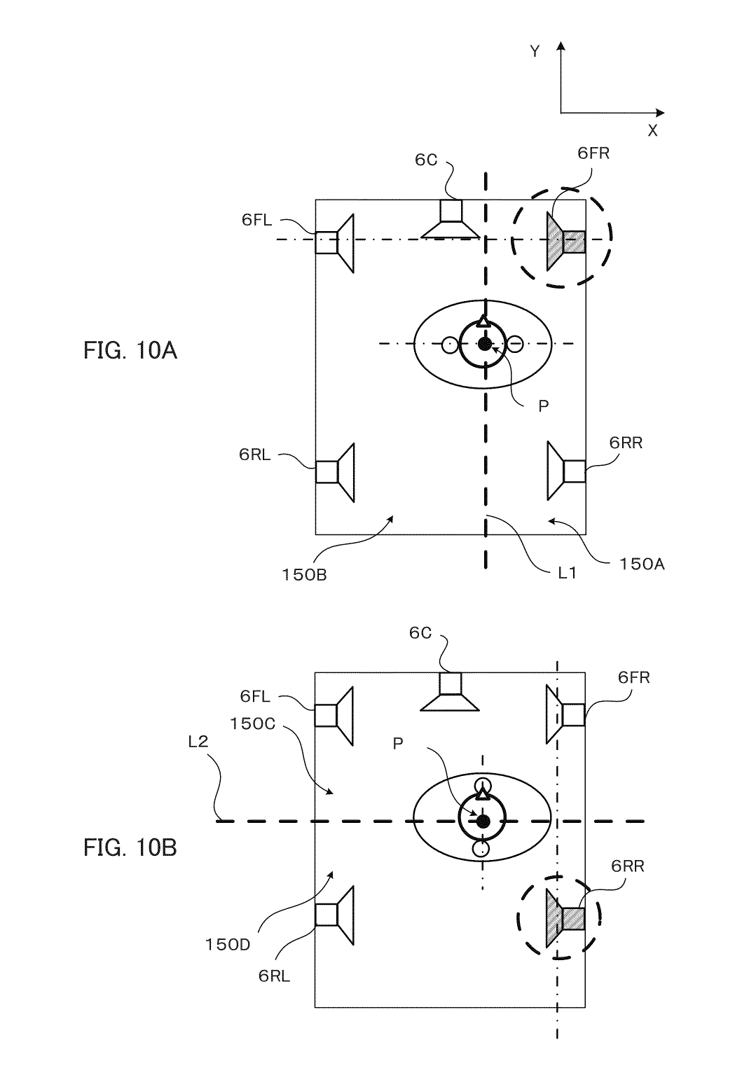

The delay adjustment object speaker determining unit 56 determines the speaker 6 subjected to the delay adjustment, based on the arrangement of the speakers 6. The method of determining the speaker 6 subjected to the delay adjustment will be described with reference to FIGS. 10A and 10B. The delay adjustment object speaker determining unit 56 divides the acoustic space by the axis reference line, which is perpendicular to the axis (the X-axis or the Y-axis) and which passes through the center position of the listening position RV, into two areas and determines the area including smaller number of the speakers 6. Then, the delay adjustment object speaker determining unit 56 determines the speaker 6 closest to the listening position RV, out of the speakers 6 belonging to the area having smaller number of speakers 6, as the delay adjustment object speaker.

As illustrated in FIG. 10A, when the speaker subjected to the delay amount variation based on the level difference on the X-axis is determined, the delay adjustment object speaker determining unit 56 divides the acoustic space by the axis reference line L1 perpendicular to the X-direction and passing through the center position P of the listening position RV. Then, the delay adjustment object speaker determining unit 56 determines the speaker 6FR, which belongs to the area 150A including smaller number of speakers and which is closest to the listening position RV, as the delay adjustment object speaker.

As illustrated in FIG. 10B, when the speaker subjected to the delay amount variation based on the level difference on the Y-axis is determined, the delay adjustment object speaker determining unit 56 divides the acoustic space by the axis reference line L2 perpendicular to the Y-direction and passing through the center position P of the listening position RV. Then, the delay adjustment object speaker determining unit 56 determines the speaker 6RR, which belongs to the area 150D including smaller number of speakers and which is closest to the listening position RV, as the delay adjustment object speaker.

As described in the above examples, the audio system 100 limits the speaker 6 subjected to the correction and performs the correction. Therefore, the correction process can be simplified by avoiding the correction of multiple speakers 6.

[Sound Field Correcting Method and Sound Field Correcting Procedure]

Next, the description will be given of the procedure of correcting the sound field by the audio system 100. The “sound field correcting process” mentioned here is such a process that the audio system 100 obtains the signals outputted by the speakers 6 arranged in front of the acoustic space from the two microphones 8A and 8B on the X-direction axis 402, adjusts the delay mount of the speakers based on the information obtained from the microphones 8A and 8B such that the level difference in the X-direction becomes substantially zero, and further adjusts the delay amount of the speakers based on the information obtained from the microphones 8C and 8D on the Y-direction axis 403 such that the level in the Y-direction becomes substantially zero.

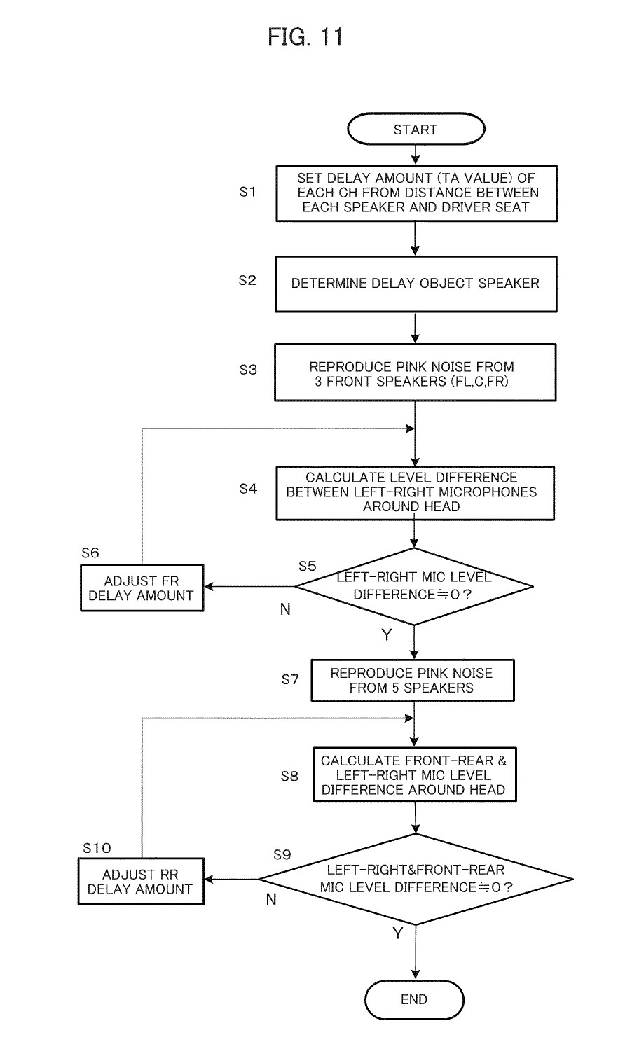

The above-mentioned sound field correcting procedure will be described with reference to the flowchart illustrated in FIG. 11. The sound field correcting procedure can be realized by executing the program on the system controller.

First, the initial correcting unit 51 sets the delay amount (TA value) of each channel based on the distances between each speaker 6 and the driver seat (the listening position RV) (step S1).

Next, the delay adjustment object speaker determining unit 56 determines the delay adjustment object speaker by the method described above (step S2). In this embodiment, the delay adjustment object speaker determining unit 56 delays the speaker 6FR when the left-right level difference is not substantially zero and delays the speaker 6RR when the front-rear level difference is not substantially zero.

Then, the measurement signal generating unit 52 generates the pink noise serving as the measurement signal, and the measurement signal outputting unit 53 outputs the pink noise from the three speakers on the front side at the same time (step S3).

Then, the measurement signal collecting unit 54 collects the pink noise, and the delay correcting unit 55 detects the level difference on the axis 402 which is the left-right axis around the head. When the level difference is not smaller than a predetermined threshold value (step S5; No), the delay correcting unit 55 varies the delay amount of the speaker 6FR (step S6). It is noted that the delay correcting unit 55 continuously varies the delay amount of the speaker 6FR until the level difference on the left-right axis becomes smaller than the predetermined threshold value (steps S4 to S6).

In this way, the delay correcting unit 55 varies the delay amount of the speaker 6FR located in the left-right direction, and the level difference in the left-right direction is improved.

When the level difference in the left-right axis is substantially zero (step S5; Yes), the measurement signal generating unit 52 generates the pink noise as the measurement signal, and the measurement signal outputting unit 53 outputs the pink noise from the five speakers 6 in the acoustic space at the same time (step S7).

The measurement signal collecting unit 54 collects the pink noise, and the delay correcting unit 55 calculates the microphone level difference in the front-rear axis (axis 403) and the left-right axis (step S8). When the microphone level difference is not substantially zero in both the front-rear axis and the left-right axis (step S9; No), the delay correcting unit 55 varies the delay amount of the speaker 6RR (step S10). It is noted that the delay correcting unit 55 varies the delay amount of the speaker 6RR until the microphone level difference in both of the left-right axis and the front-rear axis becomes substantially zero.

Then, when the microphone level difference becomes substantially zero in both the left-right axis and the front-rear axis (step S9; Yes), the sound field correcting procedure is ended.

In step S9, it is determined whether or not the microphone level difference is substantially zero in both the front-rear axis and the left-right axis. However, it is possible that the microphone level difference in the left-right axis is not calculated, because the microphone level difference in the left-right axis is made substantially zero in step S5 and it is not likely that the microphone level difference in the left-right axis is not substantially zero.

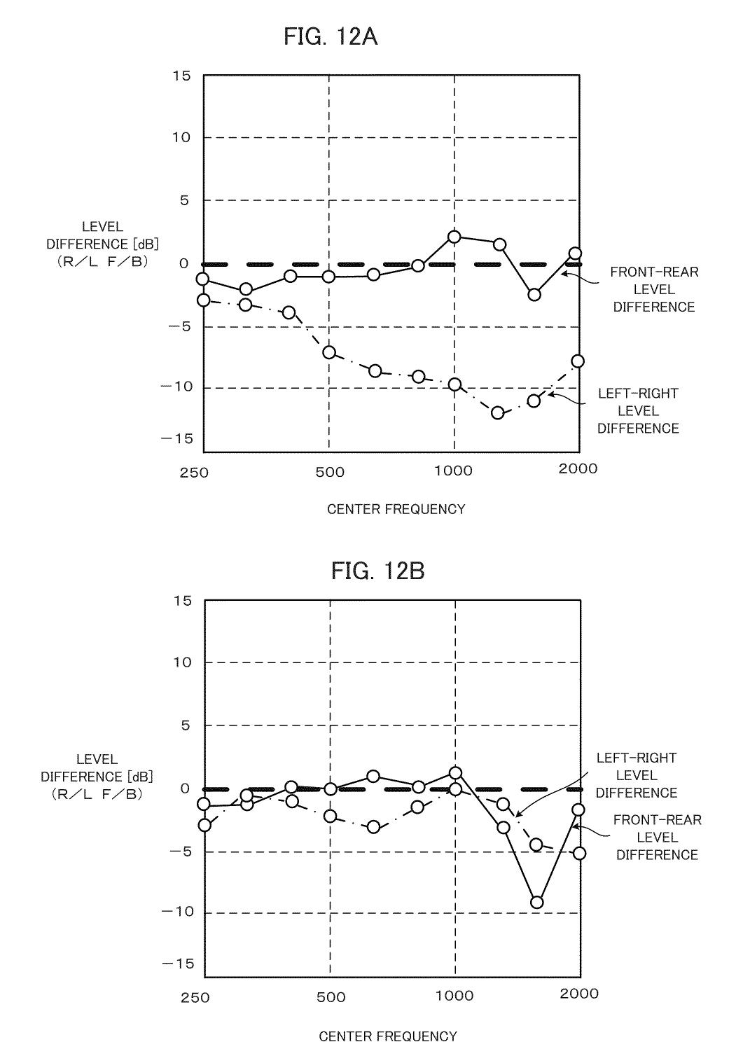

FIG. 12A illustrates the microphone level difference in the left-right axis and the front-rear axis when the conventional sound field correcting method is performed, and FIG. 12B illustrates the microphone level difference in the left-right axis and the front-rear axis when the sound field correcting method according to the present invention is performed.

As illustrated in FIGS. 12A and 12B, by the sound field correcting method of the present invention, the microphone level difference in the left-right axis is improved, in comparison with the conventional sound field correcting method.

In this way, the sound field correcting device 1 directs the attention to the microphone level difference in the left-right direction of the user, and adjusts the delay amount of the speaker so as to improve the microphone level difference. Therefore, better acoustic space can be provided in comparison with the conventional method.

As described above, a sound field correcting device, which performs sound field correction for at least two speakers arranged in a left-right direction in an acoustic space, includes: a measurement signal generating unit which generates a measurement signal; a measurement signal outputting unit which outputs the measurement signal from the two speakers, at a same time, as the measurement signal for the left-right direction of the acoustic space; a measurement signal collecting unit which collects the measurement signal for the left-right direction from at least two positions along a left-right direction axis in the acoustic space; and a delay correcting unit which performs delay adjustment for any one of the speakers in the acoustic space, based on information that the measurement signal collecting unit obtains by collecting the measurement signal for the left-right direction, until a level difference in the left-right direction becomes equal to or smaller than a predetermined value.

In this case, the sound field correcting device collects the measurement signal from two positions along the left-right (lateral) direction axis, and reduces the level difference in the left-right direction based on the information obtained by collecting the sound. Therefore, it is possible to reduce the difference between the left-right sound pressure levels at the listening position, generated when a simple time-alignment is performed based on the distances between the listening position and the speakers, thereby providing more appropriate acoustic space.

Further, the above audio system 100 includes at least one speaker 6 in the longitudinal direction. The measurement signal generating unit 52 outputs the measurement signal of the longitudinal direction (Y-direction) from all the speakers 6 at the same time, and the delay correcting unit 52 performs the delay adjustment of the speaker 6 in the longitudinal direction based on the information obtained by collecting the measurement signal in the longitudinal direction until the level difference in the longitudinal direction becomes smaller than a predetermined value. In this case, since the delay correcting unit 55 detect not only the level difference in the lateral direction but the level difference in the longitudinal direction of the acoustic space and corrects the delay amount such that the level difference in the longitudinal direction becomes smaller, the audio system 100 can provide more appropriate acoustic space.

Further, in the above-mentioned audio system 100, the initial correcting unit 51 sets predetermined delay values to the speakers in the acoustic space in advance. In this case, since the sound field correcting device sets the delay value in advance, the number of times of correcting the sound field can be reduced.

While the audio system 100 reduces the level difference in the X-direction or the Y-direction in the above embodiment, the present invention is not limited to this example. The audio system 100 may perform the correction so as to reduce the level difference on other axis.

### INDUSTRIAL APPLICABILITY

This invention can be used for a device which corrects a sound field.

1. A sound field correcting device which performs sound field correction for at least two speakers arranged in a left-right direction in an acoustic space, comprising:
a measurement signal generating unit which generates a measurement signal;
a measurement signal outputting unit which outputs the measurement signal from the two speakers, at a same time, as the measurement signal for the left-right direction of the acoustic space;
a measurement signal collecting unit which collects the measurement signal for the left-right direction from at least two positions along a left-right direction axis in the acoustic space; and
a delay correcting unit which performs delay adjustment for any one of the speakers in the acoustic space, based on information that the measurement signal collecting unit obtains by collecting the measurement signal for the left-right direction, until a level difference in the left-right direction becomes equal to or smaller than a predetermined value.

2. The sound field correcting device according to claim 1, wherein the delay correcting unit performs the delay adjustment for the speakers arranged in the left-right direction.

3. The sound field correcting device according to claim 1,
wherein the acoustic space includes at least a speaker arranged in a longitudinal direction, in addition to the speakers arranged in the left-right direction,
wherein the measurement signal outputting unit makes the speakers in the acoustic field output a measurement signal for the longitudinal direction at the same time,
wherein the measurement signal collecting unit collects the measurement signal for the longitudinal direction from at least two positions along a longitudinal direction axis in the acoustic space, and
wherein the delay correcting unit performs the delay adjustment for the speaker arranged in the longitudinal direction, based on information obtained by collecting the measurement signal for the longitudinal direction, until a level difference in the longitudinal direction becomes equal to or smaller than a predetermined value.

4. The sound field correcting device according to claim 1, wherein predetermined delay values are set beforehand for the speakers arranged in the acoustic space.

5. The sound field correcting device according to claim 2, wherein the delay correcting unit performs the delay adjustment for the speaker belonging to one of areas, which is created by dividing the acoustic space by a first reference axis perpendicular to the left-right direction and passing through a listening position located at a center of the measurement signal collecting unit and which includes smaller number of the speakers, or for the speaker arranged closer to the listening position, when the delay correcting unit performs the delay adjustment for the speakers arranged in the left-right direction.

6. The sound field correcting device according to claim 3, wherein the delay correcting unit performs the delay adjustment for the speaker belonging to one of areas, which is created by dividing the acoustic space by a second reference axis perpendicular to the longitudinal direction and passing through a center of the listening position and which includes smaller number of the speakers, or for the speaker arranged closer to the listening position, when the delay correcting unit performs the delay adjustment for the speaker arranged in the longitudinal direction.

7. A sound field correcting method which performs sound field correction for at least two speakers arranged in a left-right direction in an acoustic space, comprising:
a measurement signal generating process which generates a measurement signal;
a measurement signal outputting process which outputs the measurement signal from the two speakers, at a same time, as the measurement signal for the left-right direction of the acoustic space;
a measurement signal collecting process which collects the measurement signal for the left-right direction from the at least two positions along a left-right direction axis in the acoustic space; and
a delay correcting process which performs delay adjustment for any one of the speakers in the acoustic space, based on information that the measurement signal collecting process obtains by collecting the measurement signal for the left-right direction, until a level difference in the left-right direction becomes equal to or smaller than a predetermined value.

8. A computer program product stored in a non-transient tangible computer-readable medium and executed by a device which performs sound field correction for at least two speakers arranged in a left-right direction in an acoustic space, the computer program product, when operated, causing the device to function as:
a measurement signal generating unit which generates a measurement signal;
a measurement signal outputting unit which outputs the measurement signal from the two speakers, at a same time, as the measurement signal for the left-right direction of the acoustic space;
a measurement signal collecting unit which collects the measurement signal for the left-right direction from the at least two positions along a left-right direction axis in the acoustic space; and
a delay correcting unit which performs delay adjustment for any one of the speakers in the acoustic space, based on information that the measurement signal collecting unit obtains by collecting the measurement signal for the left-right direction, until a level difference in the left-right direction becomes equal to or smaller than a predetermined value.

9. The sound field correcting device according to claim 2,
wherein the acoustic space includes at least a speaker arranged in a longitudinal direction, in addition to the speakers arranged in the left-right direction,
wherein the measurement signal outputting unit makes the speakers in the acoustic field output a measurement signal for the longitudinal direction at the same time,
wherein the measurement signal collecting unit collects the measurement signal for the longitudinal direction from at least two positions along a longitudinal direction axis in the acoustic space, and
wherein the delay correcting unit performs the delay adjustment for the speaker arranged in the longitudinal direction, based on information obtained by collecting the measurement signal for the longitudinal direction, until a level difference in the longitudinal direction becomes equal to or smaller than a predetermined value.

10. The sound field correcting device according to claim 2, wherein predetermined delay values are set beforehand for the speakers arranged in the acoustic space.

11. The sound field correcting device according to claim 3, wherein predetermined delay values are set beforehand for the speakers arranged in the acoustic space.

12. The sound field correcting device according to claim 3, wherein the delay correcting unit performs the delay adjustment for the speaker belonging to one of areas, which is created by dividing the acoustic space by a first reference axis perpendicular to the left-right direction and passing through a listening position located at a center of the measurement signal collecting unit and which includes smaller number of the speakers, or for the speaker arranged closer to the listening position, when the delay correcting unit performs the delay adjustment for the speakers arranged in the left-right direction.

13. The sound field correcting device according to claim 4, wherein the delay correcting unit performs the delay adjustment for the speaker belonging to one of areas, which is created by dividing the acoustic space by a first reference axis perpendicular to the left-right direction and passing through a listening position located at a center of the measurement signal collecting unit and which includes smaller number of the speakers, or for the speaker arranged closer to the listening position, when the delay correcting unit performs the delay adjustment for the speakers arranged in the left-right direction.

14. The sound field correcting device according to claim 4, wherein the delay correcting unit performs the delay adjustment for the speaker belonging to one of areas, which is created by dividing the acoustic space by a second reference axis perpendicular to the longitudinal direction and passing through a center of the listening position and which includes smaller number of the speakers, or for the speaker arranged closer to the listening position, when the delay correcting unit performs the delay adjustment for the speaker arranged in the longitudinal direction.

15. The sound field correcting device according to claim 5, wherein the delay correcting unit performs the delay adjustment for the speaker belonging to one of areas, which is created by dividing the acoustic space by a second reference axis perpendicular to the longitudinal direction and passing through a center of the listening position and which includes smaller number of the speakers, or for the speaker arranged closer to the listening position, when the delay correcting unit performs the delay adjustment for the speaker arranged in the longitudinal direction.
